(19) United States
(12) Patent Application Publication
(10) Pub. No.: US 2005/0030124 A1
(43) Pub. Date: Feb. 10, 2005

(54) Transmission line transition

(76) Inventors: Douglas Seiji Okamoto, South San Francisco, CA (US); Anthony C. Sweeney, Salem, NH (US); Thomas M. Gaudette, Boston, MA (US)

Correspondence Address: KOLISCH HARTWELL, P.C., 520 S.W. YAMHILL STREET, SUITE 200, PORTLAND, OR, 97204, US

(21) Appl. No.: 10/883,398

(22) Filed: Jun. 30, 2004

Related U.S. Application Data
(60) Provisional application No. 60/484,128, filed on Jun. 30, 2003.

(51) Int. Cl. H01P 5/12; H01P 5/02

(52) U.S. Cl. 333/127; 333/33

(57) ABSTRACT

A circuit structure may include first and second transmission lines having coupled center conductors. In the first transmission line, the center conductor may be between first and second spaced-apart extended conducting surfaces, with the space between the first and second conducting surfaces forming a cavity. An example of the first transmission line is a slabline. One or more of the second transmission lines may each be coaxial transmission lines having an outer conductor substantially surrounding the associated center conductor. The center conductor of each second transmission line may be coupled to and extend orthogonally of the center conductor of the first transmission line. In some examples, the outer conductor may extend between the center conductor of the associated second transmission line and the cavity.

### RELATED APPLICATIONS

The present application claims priority from U.S. Provisional Patent Application Ser. No. 60/484,128, filed Jun. 30, 2003, incorporated herein by reference in its entirety for all purposes.

### BACKGROUND

Transmission lines provide transmission of signals between circuits and circuit components at communication frequencies, such as radio frequencies (RF). There are various types of transmission lines used for conducting signals at these frequencies. Examples' include coaxial lines, slablines, striplines, slotlines, microstrip lines and coplanar waveguides. Different transmission lines have different transmission characteristics, so the types of transmission lines used in a given system may vary to suit different circuit functions. Changes from one type of transmission line to another may involve a transition in which one type of transmission line is converted into a different type of transmission line.

### BRIEF SUMMARY OF THE DISCLOSURE

A circuit structure may include first and second transmission lines having coupled center conductors. In the first transmission line, the center conductor may be between first and second spaced-apart extended conducting surfaces, with the space between the first and second conducting surfaces forming a cavity. An example of the first transmission line is a slabline. One or more of the second transmission lines may each be coaxial transmission lines having an outer conductor substantially surrounding the associated center conductor. The center conductor of each second transmission line may be coupled to and extend orthogonally of the center conductor of the first transmission line. In some examples, the outer conductor may extend between the center conductor of the associated second transmission line and the cavity.

### BRIEF DESCRIPTION OF THE SEVERAL FIGURES

FIG. 1 an isometric view of an example of a transition between multiple coaxial transmission lines and a slabline, in which a housing is shown with phantom lines, and solid structure in the housing is shown with solid lines.

FIG. 2 is a cross section taken along line 2-2 in FIG. 1.

FIG. 3 is a cross section taken along line 3-3 in FIG. 1.

### DETAILED DESCRIPTION OF VARIOUS EMBODIMENTS

The figures illustrate a slabline transition embodiment. A slabline may include a transmission line having a round conductor between two extended parallel conducting surfaces. A strip line is a similar transmission line, in that it may include a strip or planar conductor between extended parallel conducting surfaces. Accordingly, features discussed below relating to slablines may also be applied to other forms of transmission line having one or more conducting surfaces relative to one or more signal or center conductors. Further, the conducting surface or surfaces may or may not form a shield partially or completely surrounding one or more center conductors.

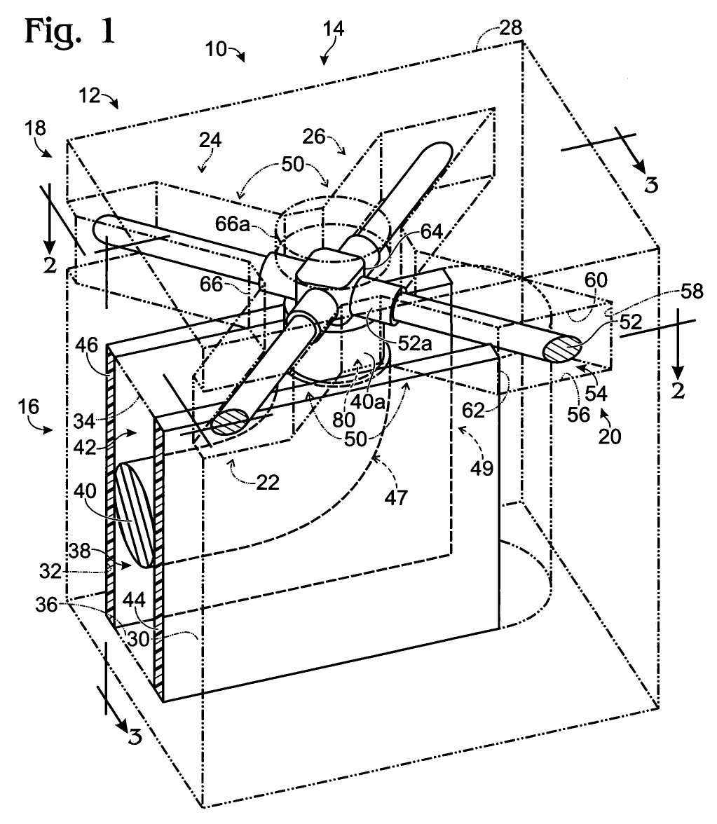

Referring then to a specific example, FIGS. 1-3 depict a circuit structure 10 that includes in one aspect, a transmission line transition 12, and in another aspect, a power combiner/divider 14. In this example, structure 10 includes a first transmission line 16 in the form of a slabline, and a set 18 of transmission lines coupled to the first transmission line. The set of transmission lines in this example are coaxial transmission lines, and specifically square coaxial transmission lines. Set 18, as shown, includes second, third, fourth and fifth transmission lines 20, 22, 24 and 26.

In this example, the transmission lines are formed in a common conductive housing 28 shown as a block of solid material. Housing 28 may also be formed in two or more parts that are held together by suitable attaching devices or materials, or may be formed as plates or layers on other substrates, and may be continuous or discontinuous, such as patterned or mesh-like in form, as appropriate to provide one or more effective conducting surfaces. The conducting surface or surfaces may be planar, curved or irregular, depending on the application. In examples in which a plurality of conducting surfaces are included, opposite conducting surfaces may be parallel or non-parallel.

In the example at hand, transmission line 16 is a slabline and includes primary, extended opposite and parallel conducting surfaces 30 and 32, and secondary conducting surfaces 34 and 36. These conducting surfaces form a continuous shield 38 surrounding a center conductor 40 having a circular cross section with a diameter D1. In a slabline, the primary conducting surfaces may be longer or more extensive than the secondary surfaces. Shield 38, then, defines a cavity 42 that may be filled by appropriate dielectric material, whether solid, liquid or gas in form, or a combination of such materials. In this example, cavity 42 is shown partially loaded, being filled with a combination of air and solid dielectric materials. The solid dielectric in this example includes suitable dielectric plates 44 and 46 that extend between conductor 40 and conducting surfaces 30 and 32. Conductor 40 forms a bend 47 in a plane 48 centered between and parallel to primary conducting surfaces 30 and 32. As shown in FIG. 3, which view corresponds with plane 48, bend 47 forms a 90° turn, although such a bend may not be required, and when provided, may be more or less than 90°. Conductor 40 has an end 40a that extends out of cavity 42 and has a reduced diameter D2.

Transmission line 16 has an end 49 adjacent to ends 50 of transmission lines 20, 22, 24 and 26. These ends form transition 12 between the slabline and one or more of the coaxial transmission lines, and provide signal combining and/or dividing as combiner/divider 14.

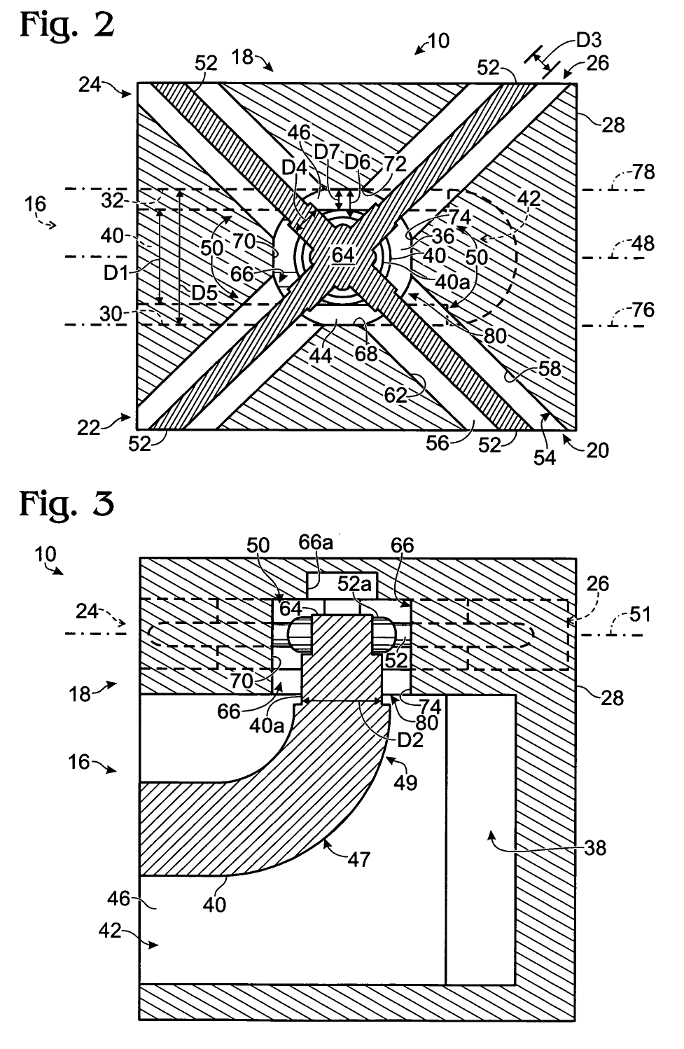

Transmission lines 20, 22, 24 and 26 are, but are not required to be, disposed in a common plane 51 corresponding to the plane of the view in FIG. 2. These transmission lines also have, but are not required to have, similar or identical structure. Accordingly, the following description of transmission line 20 is applicable to all four of these transmission lines. As a square coaxial transmission line, transmission line 20 includes a center conductor 52, which may be composed of one or two or more individual interconnecting conductors, and may have a circular cross section with a diameter D3. The center conductors may also have other shapes, such as a square cross-section. Surrounding the center conductor, with air as a dielectric, is a shield 54 formed of four equal-width conducting surfaces 56, 58, 60 and 62. These conducting surfaces form a continuous surface surrounding a center conductor, although a continuous surface is not required.

An intermediate conductor in the form of a hub 64, connects conductor 40 to conductors 52. Each conductor 52 has and end 52a with a diameter D4 that is larger than the diameter D3 of the main coaxial center conductor. Hub 64 has a size that is intermediate in size between the ends of conductors 40 and 52. The sizes of these conductors are selected to provide impedance matching through the transition between the transmission lines. Housing 28 also forms an intermediate shield 66 having conducting surfaces 68, 70, 72 and 74, extending around hub 64 between shields 38 and 54, as shown in FIG. 3. Shield 66 also includes a cap or recess 66a extending above the hub, which recess functions as a tuning feature for impedance matching.

In FIG. 2, it is seen that shield 66 has a rounded square shape, with a width D5 that is substantially the same width as shield 38 between primary conducting surfaces 30 and 32. The dimension may also be more or less than the width of shield 38. As a result, shields 54 of the coaxial transmission lines are seen to extend in toward hub 64 between planes 76 and 78 of conducting surfaces 30 and 32, corresponding to the edges of cavity 42.

The electrical ground provided by housing 28 between the slabline and the junction of the square coaxial transmission lines, represented by conducting surfaces 68, 70, 72 and 74, are positioned relatively close to conductor end 40a. This intermediate shield 66 and conductor end 40a form what may be considered an intermediate coaxial transmission line 80 having air as a dielectric. It is seen that the spacing D6 is slightly more than the thickness D7 of dielectric plates 44 and 46, due to the slightly decreased size of conductor end 40a. This spacing reduces the phase variation that is produced between the square coaxial transmission lines and the slablines, compared to that produced by a wider spacing.

FIGS. 1-3 thus are seen to illustrate both a transition from a slabline to a square coaxial line, and a combiner/divider that provides connection between a slabline and four square coaxial transmission lines. Other forms of transmission lines and different numbers of transmission lines may also be used, sized, shaped and configured as appropriate for other applications. Accordingly, while embodiments have been particularly shown and described with reference to the foregoing disclosure, many variations may be made therein. The foregoing embodiments are illustrative, and no single feature or element is essential to all possible combinations that may be used in a particular application. Where the claims recite “a” or “a first” element or the equivalent thereof, such claims include one or more such elements, neither requiring nor excluding two or more such elements. Further, ordinal indicators, such as first, second or third, for identified elements are used to distinguish between the elements, and do not indicate or imply a required or limited number of such elements, and do not indicate a particular position or order of such elements unless otherwise specifically stated.

### INDUSTRIAL APPLICABILITY

The methods and apparatus described in the present disclosure are applicable to the telecommunications and other communication frequency signal processing industries involving the transmission of signals between circuits or circuit components.

1. A circuit structure comprising:
a first transmission line having a first center conductor between first and second spaced-apart extended conducting surfaces, with the space between the first and second conducting surfaces forming a first cavity; and
one or more second coaxial transmission lines having a second center conductor and a third conductor substantially surrounding the second center conductor, each second center conductor extending orthogonally of the first center conductor and having an end coupled to an end of the first center conductor, each third conductor extending at least to a point between the second center conductor and the cavity.

2. The circuit structure of claim 1, further comprising a plurality of the second transmission lines, and a first intermediate conductor connected to each second center conductor and coupling the second center conductors to the first center conductor, the second center conductors extending in a common plane from the intermediate conductor.

3. The circuit structure of claim 2, of which the first center conductor has a first size, each second center conductor has a second size different than the first size, and the intermediate conductor has a third size between the first and second sizes.

4. The circuit structure of claim 2, of which the second center conductors are distributed equiangularly about the intermediate conductor.

5. The circuit structure of claim 2, of which the intermediate conductor has a center aligned with a center of the cavity between the first and second conducting surfaces, the first and second conducting surfaces are spaced apart a first width, and the periphery of each third conductor extends substantially to within one half of the first width of the center of the intermediate conductor.

6. The circuit structure of claim 2, further comprising a second cavity extending around the intermediate conductor and away from the first conductor beyond the third conductors.

7. The circuit structure of claim 1, of which each third conductor extends at least in line with the cavity.

8. A circuit structure comprising:
a first transmission line having a first center conductor between first and second spaced-apart extended conducting surfaces, with the space between the first and second conducting surfaces forming a first cavity;
an intermediate conductor connected to an end of the first center conductor adjacent to an end of the cavity; and
a plurality of coaxial transmission lines, each coaxial transmission line having a second center conductor and a third conductor substantially surrounding the second center conductor, each second center conductor extending orthogonally of the first center conductor and having an end connected to the intermediate conductor.

9. The circuit structure of claim 8, of Which the first center conductor has a first size, each second center conductor has a second size different than the first size, and the intermediate conductor has a third size between the first and second sizes.

10. The circuit structure of claim 8, of which the second center conductors are distributed equiangularly about the intermediate conductor.

11. The circuit structure of claim 10, of which the first and second conducting surfaces are planar and parallel, and the second center conductors are distributed symmetrically about a plane parallel to the conducting surfaces and centered between the conducting surfaces.

12. The circuit structure of claim 8, of which the intermediate conductor has a center aligned with a center of the cavity between the first and second conducting surfaces, the first and second conducting surfaces are spaced apart a first width, and the periphery of each third conductor extends substantially to within one half of the first width of the center of the intermediate conductor.

13. The circuit structure of claim 8, of which each third conductor extends at least in line with the cavity.

14. The circuit structure of claim 8, further comprising a second cavity extending around the intermediate conductor and away from the first conductor beyond the third conductors.

15. A circuit structure comprising:
a first slabline having a first center conductor surrounded by a shield defining a cavity and having first and second extended, spaced-apart parallel primary conducting surfaces, the first center conductor having a circular cross section with a first radius of curvature;
an intermediate conductor connected to an end of the first center conductor adjacent to an end of the cavity; and
a plurality of square coaxial transmission lines, each coaxial transmission line having a second center conductor connected to the intermediate conductor and extending orthogonally of the first center conductor, and a third conductor substantially surrounding the second center conductor and having four sides extending toward the intermediate conductor to a position in line with the cavity between the first and second conducting surfaces, the second center conductors being distributed equiangularly about the intermediate conductor.
